(19) United States
(12) Patent Application Publication
(10) Pub. No.: US 2022/0044290 A1
(43) Pub. Date: Feb. 10, 2022

(54) METHODS, SYSTEMS, COMPUTER READABLE MEDIA AND RELATED ASPECTS FOR TRANSPORTATION DEVICE RECONDITIONING MANAGEMENT

(71) Applicant: DealerDMS LLC, Lewes, DE (US)

(72) Inventor: Martyn OLLIVER, Lewes, DE (US)

(21) Appl. No.: 17/398,472

(22) Filed: Aug. 10, 2021

Related U.S. Application Data
(60) Provisional application No. 63/063,496, filed on Aug. 10, 2020.

(51) Int. Cl. G06Q 30/02; G06Q 10/00

(52) U.S. Cl. CPC G06Q 30/0283; G06Q 10/20

(57) ABSTRACT

Provided herein are methods of reconditioning a transportation device. The methods include creating a pending reconditioning task record that comprises a pending reconditioning task associated with the transportation device, identifying a minimum target profit margin value for a sale of the transportation device, and sending an outbound bid and/or an inbound bid request to perform the pending reconditioning task to a population of target vendors. The methods also include receiving an acceptance of the outbound bid or accepting an inbound bid to form a pending reconditioning task agreement with a selected vendor from the population of target vendors, tracking performance of the pending reconditioning task agreement by the selected vendor, and updating the pending reconditioning task record when the selected vendor completes performance of the pending reconditioning task agreement to produce an updated reconditioning task record. Related systems and computer readable media are also provided.

### BACKGROUND

Dealer management systems (DMS) are software platforms that dealers frequently use to manage vehicle inventory, customer information, and vehicle transactions, among other aspects related to the sale of automobiles or other transportation devices. In the area of used car sales, for example, numerous costs associated with a given vehicle need to be tracked, or otherwise accounted for, to ensure that the ultimate sale of the vehicle is profitable for the dealer. The complexity of such cost tracking increases dramatically as inventory size increases. One type of cost often incurred in connection with sale of used vehicles is reconditioning cost, which is the cost incurred by the dealer to perform refurbishments needed to put a given used vehicle in a condition to be offered for sale. Examples of such reconditioning tasks include windshield repair or replacement, tire repair or replacement, collision repair, paint repair, and battery replacement, among numerous other possible tasks. Oftentimes, multiple vendors are needed to completely recondition a used vehicle, which adds further complexity to managing reconditioning status and cost of any given used vehicle, let alone large inventories of such vehicles. Pre-existing DMS lack sufficient functionality to enable vehicle dealers to readily track the cost and status of reconditioning tasks, particularly when numerous vendors and large vehicle inventories are involved.

Accordingly, there is a need for additional methods, and related aspects, of managing reconditioning tasks for transportation devices.

### SUMMARY

The present disclosure relates, in certain aspects, to methods of managing the cost and status of reconditioning tasks related to transportation devices to ensure, for example, that transactions are economically favorable to transportation device dealers and that the status of reconditioning tasks is ascertainable by such dealers in substantially real-time. These and other aspects will be apparent upon a complete review of the present disclosure, including the accompanying figures.

In one aspect, the present disclosure provides a method of reconditioning a transportation device at least partially using a computer. The method includes creating, by the computer, a pending reconditioning task record that comprises at least one pending reconditioning task associated with the transportation device, and identifying, by the computer, a minimum target profit margin value for a sale of the transportation device. The minimum target profit margin value comprises a minimum target sales price value of the transportation device less a maximum total actual cost value of the transportation device, which maximum total actual cost value comprises at least one maximum total reconditioning task cost value that comprises at least one maximum pending reconditioning task cost value for completing the pending reconditioning task. The method also includes sending at least one outbound bid and/or at least one inbound bid request to perform the pending reconditioning task at or less than the maximum pending reconditioning task cost value to a population of target vendors. The method also includes receiving at least one acceptance of the outbound bid to perform the pending reconditioning task at or less than the maximum pending reconditioning task cost value from at least one of the target vendors and/or accepting at least one inbound bid received in response to the inbound bid request to perform the pending reconditioning task at or less than the maximum pending reconditioning task cost value from at least one of the target vendors to form at least one pending reconditioning task agreement with a selected vendor from the population of target vendors. The method also includes tracking, by the computer, performance of the pending reconditioning task agreement by the selected vendor, and updating, by the computer, the pending reconditioning task record at least when the selected vendor completes performance of the pending reconditioning task agreement to produce an updated reconditioning task record, thereby reconditioning the transportation device.

In some embodiments, the method includes inputting condition information about the transportation device at least when creating the pending reconditioning task record. In some embodiments, the method includes inputting transportation device data about the transportation device at least when creating the pending reconditioning task record.

In some embodiments, the method includes identifying the minimum target profit margin value and/or the minimum target sales price value using one or more datasets selected from the group consisting of: wholesale transaction data, retail transaction data, geographic data, demographic data, transportation device data, and condition data. In some embodiments, the minimum target sales price value comprises a wholesale price value and the method comprises identifying the minimum target profit margin value and/or the minimum target sales price value using at least one wholesale pricing model. In some embodiments, the minimum target sales price value comprises a retail price value and the method comprises identifying the minimum target profit margin value and/or the minimum target sales price value using at least one retail pricing model. In some embodiments, the method includes identifying the maximum total reconditioning task cost value and/or the maximum pending reconditioning task cost value using at least one transportation device reconditioning pricing model.

In some embodiments, the method includes notifying at least one user of the updated reconditioning task record. In some embodiments, the transportation device is a new transportation device. In some embodiments, the transportation device is a used transportation device. In some embodiments, the method includes selling the transportation device during or after updating the pending reconditioning task record.

In some embodiments, the pending reconditioning task comprises replacing or repairing at least one part of the transportation device and/or performing at least one service associated with the transportation device. In some embodiments, the pending reconditioning task record comprises multiple pending reconditioning tasks associated with the transportation device. In some embodiments, the method includes sending or receiving a payment at or from one or more users to or from one or more members of the population of target vendors during and/or after sending the outbound bid and/or the inbound bid request to the population of target vendors. In some embodiments, the population of target vendors comprises about 2, about 3, about 4, about 5, about 6, about 7, about 8, about 9, about 10, or more vendors for a given pending reconditioning task associated with the transportation device. In some embodiments, the transportation device is a vehicle selected from the group consisting of: an automobile, a truck, a recreational vehicle, a marine device, an airplane, and a motorcycle. In some embodiments, the method is implemented as part of at least one dealer management system (DMS) and/or at least one transportation device data system.

In some embodiments, the method includes determining condition information about the transportation device prior to and/or when creating the pending reconditioning task record. In some of these embodiments, the condition information comprises mechanical information, electrical information, and/or aesthetic information about the transportation device. In some embodiments, the method includes the population of target vendors comprises at least one preapproved group of vendors. In some of these embodiments, the method includes sending the outbound bid and/or the inbound bid request to one or more unapproved vendors.

In another aspect, the present disclosure provides a system, comprising a controller comprising, or capable of accessing, computer readable media comprising non-transitory computer-executable instructions which, when executed by at least one electronic processor perform at least creating a pending reconditioning task record that comprises at least one pending reconditioning task associated with at least one transportation device. The instructions also perform identifying a minimum target profit margin value for a sale of the transportation device, wherein the minimum target profit margin value comprises a minimum target sales price value of the transportation device less a maximum total actual cost value of the transportation device, which maximum total actual cost value comprises at least one maximum total reconditioning task cost value that comprises at least one maximum pending reconditioning task cost value for completing the pending reconditioning task. The instructions also perform sending at least one outbound bid and/or at least one inbound bid request to perform the pending reconditioning task at or less than the maximum pending reconditioning task cost value to a population of target vendors. The instructions also perform receiving at least one acceptance of the outbound bid to perform the pending reconditioning task at or less than the maximum pending reconditioning task cost value from at least one of the target vendors and/or accepting at least one inbound bid received in response to the inbound bid request to perform the pending reconditioning task at or less than the maximum pending reconditioning task cost value from at least one of the target vendors to form at least one pending reconditioning task agreement with a selected vendor from the population of target vendors. The instructions also perform tracking performance of the pending reconditioning task agreement by the selected vendor, and updating the pending reconditioning task record at least when the selected vendor completes performance of the pending reconditioning task agreement to produce an updated reconditioning task record.

In another aspect, the present disclosure provides a computer readable media comprising non-transitory computer-executable instructions which, when executed by at least one electronic processor perform at least creating a pending reconditioning task record that comprises at least one pending reconditioning task associated with at least one transportation device. The instructions also perform identifying a minimum target profit margin value for a sale of the transportation device, wherein the minimum target profit margin value comprises a minimum target sales price value of the transportation device less a maximum total actual cost value of the transportation device, which maximum total actual cost value comprises at least one maximum total reconditioning task cost value that comprises at least one maximum pending reconditioning task cost value for completing the pending reconditioning task. The instructions also perform sending at least one outbound bid and/or at least one inbound bid request to perform the pending reconditioning task at or less than the maximum pending reconditioning task cost value to a population of target vendors. The instructions also perform receiving at least one acceptance of the outbound bid to perform the pending reconditioning task at or less than the maximum pending reconditioning task cost value from at least one of the target vendors and/or accepting at least one inbound bid received in response to the inbound bid request to perform the pending reconditioning task at or less than the maximum pending reconditioning task cost value from at least one of the target vendors to form at least one pending reconditioning task agreement with a selected vendor from the population of target vendors. The instructions also perform tracking performance of the pending reconditioning task agreement by the selected vendor, and updating the pending reconditioning task record at least when the selected vendor completes performance of the pending reconditioning task agreement to produce an updated reconditioning task record.

In some embodiments of the systems and computer readable media disclosed herein, the instructions further perform at least receiving input condition information about the transportation device at least when creating the pending reconditioning task record. In some embodiments of the systems and computer readable media disclosed herein, the instructions further perform at least receiving input transportation device data about the transportation device at least when creating the pending reconditioning task record.

In some embodiments of the systems and computer readable media disclosed herein, the instructions further perform at least identifying the minimum target profit margin value and/or the minimum target sales price value using one or more datasets selected from the group consisting of: wholesale transaction data, retail transaction data, geographic data, demographic data, transportation device data, and condition data. In some embodiments of the systems and computer readable media disclosed herein, the instructions further perform at least identifying the minimum target profit margin value and/or the minimum target sales price value using at least one wholesale pricing model when the minimum target sales price value comprises a wholesale price value. In some embodiments of the systems and computer readable media disclosed herein, the instructions further perform at least identifying the minimum target profit margin value and/or the minimum target sales price value using at least one retail pricing model when the minimum target sales price value comprises a retail price value. In some embodiments of the systems and computer readable media disclosed herein, the instructions further perform at least identifying the maximum total reconditioning task cost value and/or the maximum pending reconditioning task cost value using at least one transportation device reconditioning pricing model.

In some embodiments of the systems and computer readable media disclosed herein, the instructions further perform at least notifying at least one user of the updated reconditioning task record. In some embodiments of the systems and computer readable media disclosed herein, the instructions further perform at least sending or receiving a payment at or from one or more users to or from one or more members of the population of target vendors during and/or after sending the outbound bid and/or the inbound bid request to the population of target vendors. In some embodiments of the systems and computer readable media disclosed herein, the instructions implemented as part of at least one dealer management system (DMS) and/or at least one transportation device data system.

### BRIEF DESCRIPTION OF THE DRAWINGS

The accompanying drawings, which are incorporated in and constitute a part of this specification, illustrate certain embodiments, and together with the written description, serve to explain certain principles of the methods, systems, and related computer readable media disclosed herein. The description provided herein is better understood when read in conjunction with the accompanying drawings which are included by way of example and not by way of limitation. It will be understood that like reference numerals identify like components throughout the drawings, unless the context indicates otherwise. It will also be understood that some or all of the figures may be schematic representations for purposes of illustration and do not necessarily depict the actual relative sizes or locations of the elements shown.

FIG. 1 is a flow chart that schematically shows exemplary method steps of reconditioning a transportation device according to some aspects disclosed herein.

FIG. 2 is a flow chart that schematically shows exemplary method steps of reconditioning a transportation device according to some aspects disclosed herein.

FIG. 3 is a schematic diagram of an exemplary system suitable for use with certain aspects disclosed herein.

### DEFINITIONS

In order for the present disclosure to be more readily understood, certain terms are first defined below. Additional definitions for the following terms and other terms may be set forth throughout the specification. If a definition of a term set forth below is inconsistent with a definition in an application or patent that is incorporated by reference, the definition set forth in this application should be used to understand the meaning of the term.

As used in this specification and the appended claims, the singular forms “a,” “an,” and “the” include plural references unless the context clearly dictates otherwise. Thus, for example, a reference to “a method” includes one or more methods, and/or steps of the type described herein and/or which will become apparent to those persons skilled in the art upon reading this disclosure and so forth.

It is also to be understood that the terminology used herein is for the purpose of describing particular embodiments only and is not intended to be limiting. Further, unless defined otherwise, all technical and scientific terms used herein have the same meaning as commonly understood by one of ordinary skill in the art to which this disclosure pertains. In describing and claiming the methods, systems, and computer readable media, the following terminology, and grammatical variants thereof, will be used in accordance with the definitions set forth below.

About: As used herein, “about” or “approximately” or “substantially” as applied to one or more values or elements of interest, refers to a value or element that is similar to a stated reference value or element. In certain embodiments, the term “about” or “approximately” or “substantially” refers to a range of values or elements that falls within 25%, 20%, 19%, 18%, 17%, 16%, 15%, 14%, 13%, 12%, 11%, 10%, 9%, 8%, 7%, 6%, 5%, 4%, 3%, 2%, 1%, or less in either direction (greater than or less than) of the stated reference value or element unless otherwise stated or otherwise evident from the context (except where such number would exceed 100% of a possible value or element).

Acceptance: As used herein, “acceptance” in the context of agreements or contracts refers to agreeing either expressly or by conduct to the act or offer of another so that an agreement or contract is formed and the parties become legally bound.

Inbound Bid Request: As used herein, “inbound bid request” in the context of agreements or contracts refers to a first party sending a request to at least one other party to receive an offer from that other party for payment or acceptance by the first party. In some embodiments, for example, a first party sends a request to at least one other party to receive an offer from that other party to perform a service and/or sell a product at a price proposed by the other party, which offer the first party may or may not accept.

Outbound Bid: As used herein, “outbound bid” in the context of agreements or contracts refers to an offer sent from a first party to at least one other party for payment or acceptance by the other party. In some embodiments, for example, a first party offers to pay at least one other party a certain amount in return for that other party to perform a service and/or sell a product, which offer the other party may or may not accept.

### DETAILED DESCRIPTION

The present disclosure relates, in certain aspects, to methods of managing the cost and status of reconditioning tasks related to transportation devices. The methods ensure, for example, that transactions are economically favorable to transportation device dealers and that the status of reconditioning tasks is ascertainable in substantially real-time. In addition to methods of reconditioning transportation devices, the present disclosure also includes related systems and computer readable media for implementing the methods.

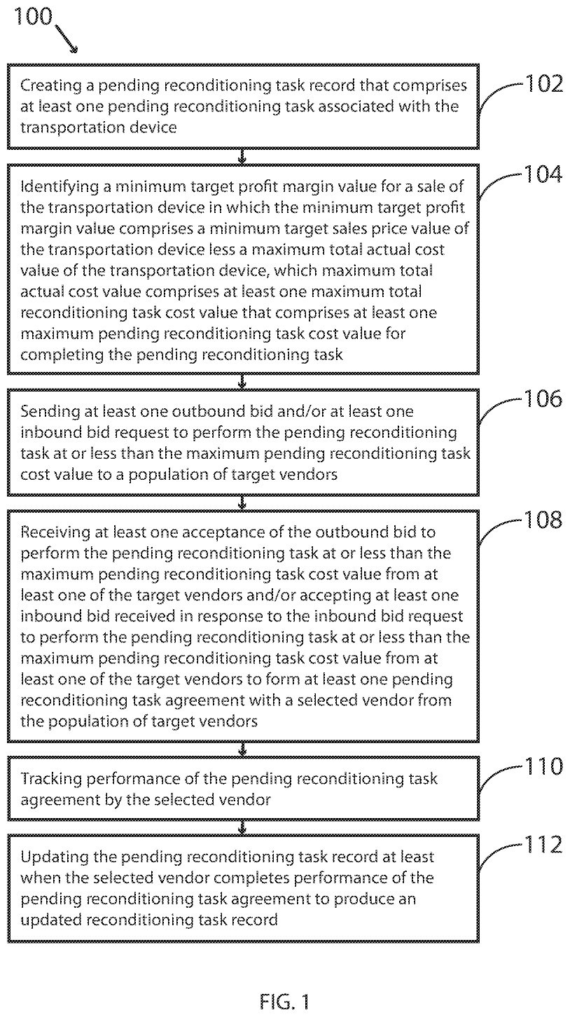

To illustrate, FIG. 1 is a flow chart that schematically shows exemplary method steps of reconditioning a transportation device, such as an automobile, a truck, a recreational vehicle, a marine device, an airplane, a motorcycle, and the like. In some embodiments, the transportation device is a new transportation device, whereas in other embodiments, the transportation device is a used transportation device. As shown, method 100 includes creating a pending reconditioning task record that comprises at least one pending reconditioning task associated with the transportation device (step 102). Method 100 is frequently implemented as part of a dealer management system (DMS) and/or a transportation device data system. Typically, method 100 includes determining condition information (e.g., mechanical information, electrical information, aesthetic information, and/or the like) about the transportation device prior to and/or when creating the pending reconditioning task record and inputting that condition information into the computer system when creating the pending reconditioning task record. Method 100 also generally includes inputting transportation device data (e.g., vehicle identification number (VIN), title information, mileage, year, make, model, costs incurred acquiring and transporting the transportation device, and the like) about the transportation device into the computer system when creating the pending reconditioning task record. The pending reconditioning task typically includes replacing or repairing at least one part of the transportation device and/or performing at least one service associated with the transportation device. Frequently, the pending reconditioning task record includes multiple pending reconditioning tasks associated with the transportation device to be completed to put the device in a condition for sale.

Method 100 also includes identifying a minimum target profit margin value for a sale of the transportation device in which the minimum target profit margin value includes a minimum target sales price value of the transportation device less a maximum total actual cost value of the transportation device (step 104). The maximum total actual cost value includes at least one maximum total reconditioning task cost value that comprises at least one maximum pending reconditioning task cost value for completing the pending reconditioning task. In some embodiments, method 100 includes identifying the minimum target profit margin value and/or the minimum target sales price value using one or more datasets, such as wholesale transaction data, retail transaction data, geographic data, demographic data, transportation device data, condition data, and/or the like. In certain embodiments, the minimum target sales price value includes a wholesale price value and method 100 includes identifying the minimum target profit margin value and/or the minimum target sales price value using a wholesale pricing model. In some embodiments, the minimum target sales price value includes a retail price value and method 100 includes identifying the minimum target profit margin value and/or the minimum target sales price value using a retail pricing model. In certain embodiments, method 100 includes identifying the maximum total reconditioning task cost value and/or the maximum pending reconditioning task cost value using a transportation device reconditioning pricing model. Exemplary wholesale pricing models, retail pricing models, and reconditioning pricing models that are optionally adapted for use in performing the methods disclosed herein are also described in U.S. Pat. No. 10,504,159, which is incorporated by reference.

In addition, method 100 also includes sending at least one outbound bid and/or at least one inbound bid request to perform the pending reconditioning task at or less than the maximum pending reconditioning task cost value to a population of target vendors (step 106). Bids are generally sent to vendors using essentially any electronic communication format (e.g., via email, text messaging, facsimile, social media portals, and the like). In some embodiments, the population of target vendors includes about 2, about 3, about 4, about 5, about 6, about 7, about 8, about 9, about 10, or more vendors for a given pending reconditioning task associated with the transportation device. In certain embodiments, the population of target vendors includes a preapproved group of vendors. In some of these embodiments, method 100 includes sending the outbound bid and/or the inbound bid request to one or more unapproved vendors. Typically, method 100 includes sending or receiving a payment at or from one or more users to or from one or more members of the population of target vendors during and/or after sending the outbound bid and/or the inbound bid request to the population of target vendors.

Method 100 also includes receiving at least one acceptance of the outbound bid to perform the pending reconditioning task at or less than the maximum pending reconditioning task cost value from at least one of the target vendors and/or accepting at least one inbound bid received in response to the inbound bid request to perform the pending reconditioning task at or less than the maximum pending reconditioning task cost value from at least one of the target vendors to form at least one pending reconditioning task agreement with a selected vendor from the population of target vendors (step 108). Method 100 also includes tracking performance of the pending reconditioning task agreement by the selected vendor (step 110) and updating the pending reconditioning task record at least when the selected vendor completes performance of the pending reconditioning task agreement to produce an updated reconditioning task record (step 112). Method 100 also generally includes notifying at least one user (e.g., an automobile dealer, etc.) of the updated reconditioning task record. Method 100 also typically includes selling the transportation device during or after updating the pending reconditioning task record.

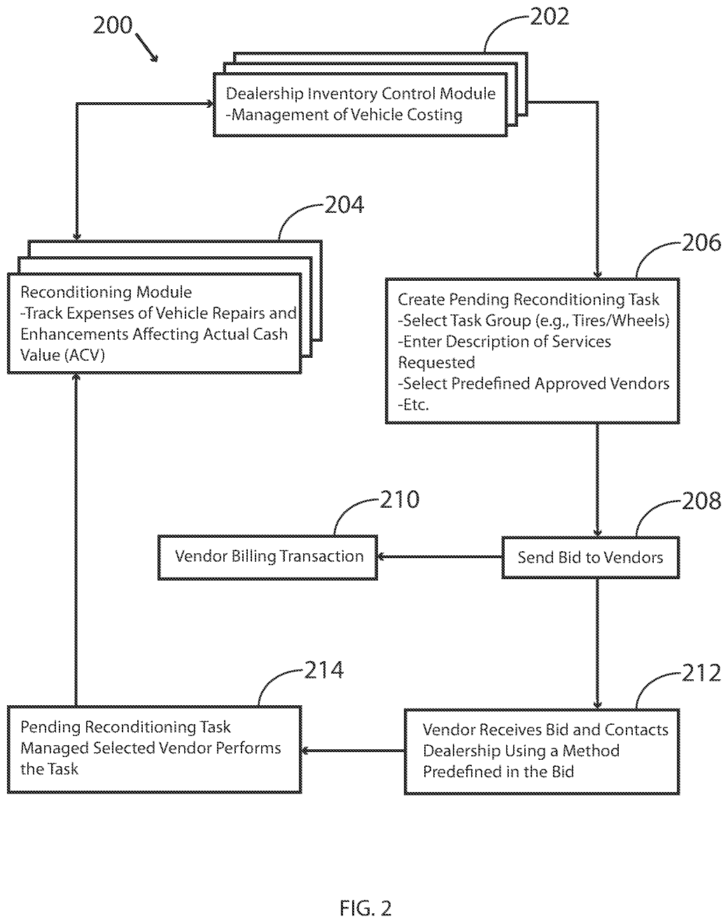

To further illustrate, FIG. 2 is a flow chart that schematically shows exemplary method steps of reconditioning a transportation device. As shown, method 200 includes computer program products having a dealership inventory control module, which among other functionality manages vehicle costing (202) and a reconditioning module, which among other functionality tracks reconditioning expenses of vehicle repairs and enhancement affecting actual cash value (ACV) (204). ACV typically includes the initial cost that a dealer pays to purchase a given transportation device, the associated reconditioning expense, and other related adjustments (e.g., for depreciation or the like). Method 200 also includes creating a pending reconditioning task, which includes, for example, selecting a task group (e.g., tires/wheels, electrical, windshields, paint, etc.), entering descriptions of services requested, and selecting predefined approved vendors, among other tasks (206). Method 200 also includes sending bids to vendors (208) and transacting vendor billing (210). In some embodiments, bids are sent to vendors via a third party that is separate from the given transportation device dealer. Method 200 also includes vendors receiving bids and contacting the dealership using a method predefined in the bid (e.g., an email, text message, etc.) (212). Method 200 also includes managing the pending reconditioning task performed by the selected vendor (214) (e.g., tracking and updating a given reconditioning task status in or via the reconditioning and dealership inventory control modules).

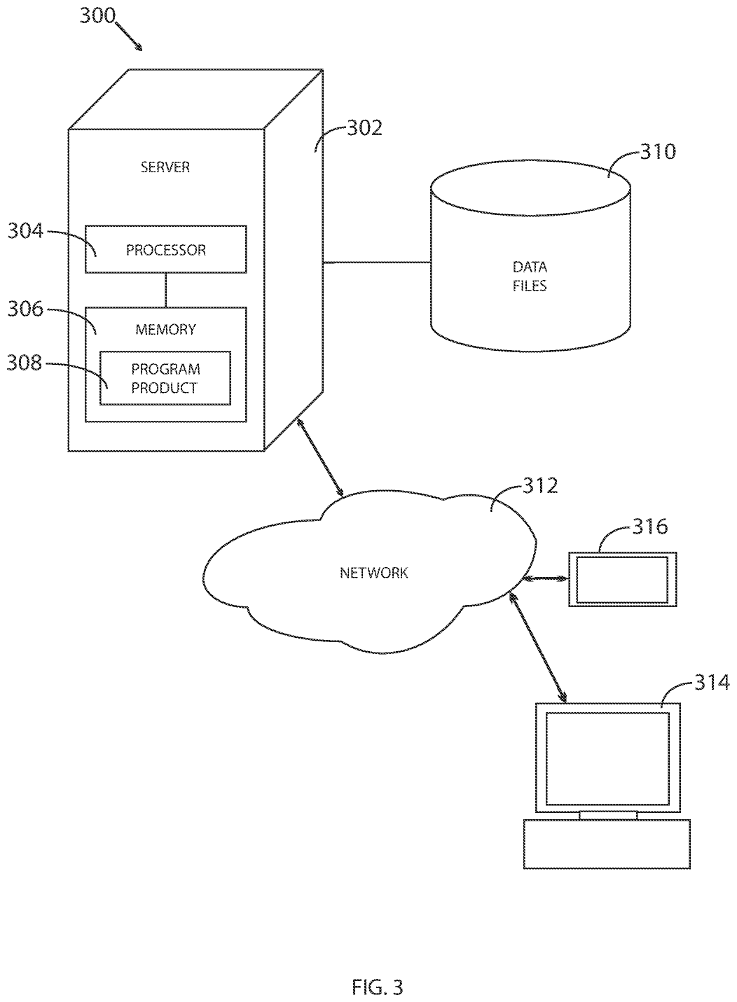

The present disclosure also provides various systems and computer program products or machine readable media. In some aspects, for example, the methods described herein are optionally performed or facilitated at least in part using systems, distributed computing hardware and applications (e.g., cloud computing services), electronic communication networks, communication interfaces, computer program products, machine readable media, electronic storage media, software (e.g., machine-executable code or logic instructions) and/or the like. To illustrate, FIG. 3 provides a schematic diagram of an exemplary system suitable for use with implementing at least aspects of the methods disclosed in this application. As shown, system 300 includes at least one controller or computer, e.g., server 302 (e.g., a search engine server), which includes processor 304 and memory, storage device, or memory component 306, and one or more other communication devices 314, 316, (e.g., client-side computer terminals, telephones, tablets, laptops, other mobile devices, etc. in communication with the remote server 302, through electronic communication network 312, such as the Internet or other internetwork. Communication devices 314, 316 typically include an electronic display (e.g., an internet enabled computer or the like) in communication with, e.g., server 302 computer over network 312 in which the electronic display comprises a user interface (e.g., a graphical user interface (GUI), a web-based user interface, and/or the like) for displaying results upon implementing the methods described herein. In certain aspects, communication networks also encompass the physical transfer of data from one location to another, for example, using a hard drive, thumb drive, or other data storage mechanism. System 300 also includes program product 308 (e.g., for managing reconditioning tasks as described herein) stored on a computer or machine readable medium, such as, for example, one or more of various types of memory, such as memory 306 of server 302, that is readable by the server 302, to facilitate, for example, a guided search application or other executable by one or more other communication devices, such as 314 (schematically shown as a desktop or personal computer). In some aspects, system 300 optionally also includes at least one database server, such as, for example, server 310 associated with an online website having data stored thereon (e.g., entries corresponding to pending reconditioning task records, etc.) searchable either directly or through search engine server 302. System 300 optionally also includes one or more other servers positioned remotely from server 302, each of which are optionally associated with one or more database servers 310 located remotely or located local to each of the other servers. The other servers can beneficially provide service to geographically remote users and enhance geographically distributed operations.

As understood by those of ordinary skill in the art, memory 306 of the server 302 optionally includes volatile and/or nonvolatile memory including, for example, RAM, ROM, and magnetic or optical disks, among others. It is also understood by those of ordinary skill in the art that although illustrated as a single server, the illustrated configuration of server 302 is given only by way of example and that other types of servers or computers configured according to various other methodologies or architectures can also be used. Server 302 shown schematically in FIG. 3, represents a server or server cluster or server farm and is not limited to any individual physical server. The server site may be deployed as a server farm or server cluster managed by a server hosting provider. The number of servers and their architecture and configuration may be increased based on usage, demand and capacity requirements for the system 300. As also understood by those of ordinary skill in the art, other user communication devices 314, 316 in these aspects, for example, can be a laptop, desktop, tablet, personal digital assistant (PDA), cell phone, server, or other types of computers. As known and understood by those of ordinary skill in the art, network 312 can include an internet, intranet, a telecommunication network, an extranet, or world wide web of a plurality of computers/servers in communication with one or more other computers through a communication network, and/or portions of a local or other area network.

As further understood by those of ordinary skill in the art, exemplary program product or machine readable medium 308 is optionally in the form of microcode, programs, cloud computing format, routines, and/or symbolic languages that provide one or more sets of ordered operations that control the functioning of the hardware and direct its operation. Program product 308, according to an exemplary aspect, also need not reside in its entirety in volatile memory, but can be selectively loaded, as necessary, according to various methodologies as known and understood by those of ordinary skill in the art.

As further understood by those of ordinary skill in the art, the term “computer-readable medium” or “machine-readable medium” refers to any medium that participates in providing instructions to a processor for execution. To illustrate, the term “computer-readable medium” or “machine-readable medium” encompasses distribution media, cloud computing formats, intermediate storage media, execution memory of a computer, and any other medium or device capable of storing program product 208 implementing the functionality or processes of various aspects of the present disclosure, for example, for reading by a computer. A “computer-readable medium” or “machine-readable medium” may take many forms, including but not limited to, non-volatile media, volatile media, and transmission media. Non-volatile media includes, for example, optical or magnetic disks. Volatile media includes dynamic memory, such as the main memory of a given system. Transmission media includes coaxial cables, copper wire and fiber optics, including the wires that comprise a bus. Transmission media can also take the form of acoustic or light waves, such as those generated during radio wave and infrared data communications, among others. Exemplary forms of computer-readable media include a floppy disk, a flexible disk, hard disk, magnetic tape, a flash drive, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave, or any other medium from which a computer can read.

Program product 308 is optionally copied from the computer-readable medium to a hard disk or a similar intermediate storage medium. When program product 308, or portions thereof, are to be run, it is optionally loaded from their distribution medium, their intermediate storage medium, or the like into the execution memory of one or more computers, configuring the computer(s) to act in accordance with the functionality or method of various aspects disclosed herein. All such operations are well known to those of ordinary skill in the art of, for example, computer systems.

To further illustrate, in certain aspects, this application provides systems that include one or more processors, and one or more memory components in communication with the processor. The memory component typically includes one or more instructions that, when executed, cause the processor to provide information that causes at least one pending reconditioning task record and/or the like to be displayed (e.g., via communication devices 314, 316 or the like) and/or receive information from other system components and/or from a system user (e.g., via communication devices 314, 316, or the like).

In some aspects, program product 308 includes non-transitory computer-executable instructions which, when executed by electronic processor 304 perform at least: creating a pending reconditioning task record that comprises at least one pending reconditioning task associated with at least one transportation device. The instructions also perform identifying a minimum target profit margin value for a sale of the transportation device, wherein the minimum target profit margin value comprises a minimum target sales price value of the transportation device less a maximum total actual cost value of the transportation device, which maximum total actual cost value comprises at least one maximum total reconditioning task cost value that comprises at least one maximum pending reconditioning task cost value for completing the pending reconditioning task. The instructions also perform sending at least one outbound bid and/or at least one inbound bid request to perform the pending reconditioning task at or less than the maximum pending reconditioning task cost value to a population of target vendors. The instructions also perform receiving at least one acceptance of the outbound bid to perform the pending reconditioning task at or less than the maximum pending reconditioning task cost value from at least one of the target vendors and/or accepting at least one inbound bid received in response to the inbound bid request to perform the pending reconditioning task at or less than the maximum pending reconditioning task cost value from at least one of the target vendors to form at least one pending reconditioning task agreement with a selected vendor from the population of target vendors. The instructions also perform tracking performance of the pending reconditioning task agreement by the selected vendor, and updating the pending reconditioning task record at least when the selected vendor completes performance of the pending reconditioning task agreement to produce an updated reconditioning task record. Other exemplary executable instructions that are optionally performed are described further herein.

Additional details relating to computer systems and networks, databases, and computer program products are also provided in, for example, Peterson, Computer Networks: A Systems Approach, Morgan Kaufmann, 5th Ed. (2011), Kurose, Computer Networking: A Top-Down Approach, Pearson, 7th Ed. (2016), Elmasri, Fundamentals of Database Systems, Addison Wesley, 6th Ed. (2010), Coronel, Database Systems: Design, Implementation, & Management, Cengage Learning, 11th Ed. (2014), Tucker, Programming Languages, McGraw-Hill Science/Engineering/Math, 2nd Ed. (2006), and Rhoton, Cloud Computing Architected: Solution Design Handbook, Recursive Press (2011), which are each incorporated by reference in their entirety.

While the foregoing disclosure has been described in some detail by way of illustration and example for purposes of clarity and understanding, it will be clear to one of ordinary skill in the art from a reading of this disclosure that various changes in form and detail can be made without departing from the true scope of the disclosure and may be practiced within the scope of the appended claims. For example, all the methods, systems, and/or computer readable media or other aspects thereof can be used in various combinations. All patents, patent applications, websites, other publications or documents, and the like cited herein are incorporated by reference in their entirety for all purposes to the same extent as if each individual item were specifically and individually indicated to be so incorporated by reference.

1. A method of reconditioning a transportation device at least partially using a computer, the method comprising:
creating, by the computer, a pending reconditioning task record that comprises at least one pending reconditioning task associated with the transportation device;
identifying, by the computer, a minimum target profit margin value for a sale of the transportation device, wherein the minimum target profit margin value comprises a minimum target sales price value of the transportation device less a maximum total actual cost value of the transportation device, which maximum total actual cost value comprises at least one maximum total reconditioning task cost value that comprises at least one maximum pending reconditioning task cost value for completing the pending reconditioning task;
sending at least one outbound bid and/or at least one inbound bid request to perform the pending reconditioning task at or less than the maximum pending reconditioning task cost value to a population of target vendors;
receiving at least one acceptance of the outbound bid to perform the pending reconditioning task at or less than the maximum pending reconditioning task cost value from at least one of the target vendors and/or accepting at least one inbound bid received in response to the inbound bid request to perform the pending reconditioning task at or less than the maximum pending reconditioning task cost value from at least one of the target vendors to form at least one pending reconditioning task agreement with a selected vendor from the population of target vendors;
tracking, by the computer, performance of the pending reconditioning task agreement by the selected vendor; and,
updating, by the computer, the pending reconditioning task record at least when the selected vendor completes performance of the pending reconditioning task agreement to produce an updated reconditioning task record, thereby reconditioning the transportation device.

2. The method of claim 1, comprising inputting condition information about the transportation device at least when creating the pending reconditioning task record and/or inputting transportation device data about the transportation device at least when creating the pending reconditioning task record.

3. (canceled)

4. The method of claim 1, comprising identifying the minimum target profit margin value and/or the minimum target sales price value using one or more datasets selected from the group consisting of: wholesale transaction data, retail transaction data, geographic data, demographic data, transportation device data, and condition data.

5. The method of claim 1, wherein the minimum target sales price value comprises a wholesale price value and the method comprises identifying the minimum target profit margin value and/or the minimum target sales price value using at least one wholesale pricing model.

6. The method of claim 1, wherein the minimum target sales price value comprises a retail price value and the method comprises identifying the minimum target profit margin value and/or the minimum target sales price value using at least one retail pricing model.

7. The method of claim 1, comprising identifying the maximum total reconditioning task cost value and/or the maximum pending reconditioning task cost value using at least one transportation device reconditioning pricing model.

8. The method of claim 1, comprising notifying at least one user of the updated reconditioning task record.

9. The method of claim 1, wherein the transportation device is a new transportation device.

10. The method of claim 1, wherein the transportation device is a used transportation device.

11. The method of claim 1, comprising selling the transportation device during or after updating the pending reconditioning task record.

12. The method of claim 1, wherein the pending reconditioning task comprises replacing or repairing at least one part of the transportation device and/or performing at least one service associated with the transportation device.

13. The method of claim 1, wherein the pending reconditioning task record comprises multiple pending reconditioning tasks associated with the transportation device.

14. The method of claim 1, comprising sending or receiving a payment at or from one or more users to or from one or more members of the population of target vendors during and/or after sending the outbound bid and/or the inbound bid request to the population of target vendors.

15. The method of claim 1, wherein the population of target vendors comprises about 2, about 3, about 4, about 5, about 6, about 7, about 8, about 9, about 10, or more vendors for a given pending reconditioning task associated with the transportation device.

16. (canceled)

17. The method of claim 1, wherein the method is implemented as part of at least one dealer management system (DMS) and/or at least one transportation device data system.

18. The method of claim 1, comprising determining condition information about the transportation device prior to and/or when creating the pending reconditioning task record.

19. (canceled)

20. The method of claim 1, wherein the population of target vendors comprises at least one preapproved group of vendors.

21. The method of claim 1, comprising sending the outbound bid and/or the inbound bid request to one or more unapproved vendors.

22. A system, comprising a controller comprising, or capable of accessing, computer readable media comprising non-transitory computer-executable instructions which, when executed by at least one electronic processor perform at least:
creating a pending reconditioning task record that comprises at least one pending reconditioning task associated with at least one transportation device;
identifying a minimum target profit margin value for a sale of the transportation device, wherein the minimum target profit margin value comprises a minimum target sales price value of the transportation device less a maximum total actual cost value of the transportation device, which maximum total actual cost value comprises at least one maximum total reconditioning task cost value that comprises at least one maximum pending reconditioning task cost value for completing the pending reconditioning task;
sending at least one outbound bid and/or at least one inbound bid request to perform the pending reconditioning task at or less than the maximum pending reconditioning task cost value to a population of target vendors;
receiving at least one acceptance of the outbound bid to perform the pending reconditioning task at or less than the maximum pending reconditioning task cost value from at least one of the target vendors and/or accepting at least one inbound bid received in response to the inbound bid request to perform the pending reconditioning task at or less than the maximum pending reconditioning task cost value from at least one of the target vendors to form at least one pending reconditioning task agreement with a selected vendor from the population of target vendors;
tracking performance of the pending reconditioning task agreement by the selected vendor; and,
updating the pending reconditioning task record at least when the selected vendor completes performance of the pending reconditioning task agreement to produce an updated reconditioning task record.

23. A computer readable media comprising non-transitory computer-executable instructions which, when executed by at least one electronic processor perform at least:
creating a pending reconditioning task record that comprises at least one pending reconditioning task associated with at least one transportation device;
identifying a minimum target profit margin value for a sale of the transportation device, wherein the minimum target profit margin value comprises a minimum target sales price value of the transportation device less a maximum total actual cost value of the transportation device, which maximum total actual cost value comprises at least one maximum total reconditioning task cost value that comprises at least one maximum pending reconditioning task cost value for completing the pending reconditioning task;
sending at least one outbound bid and/or at least one inbound bid request to perform the pending reconditioning task at or less than the maximum pending reconditioning task cost value to a population of target vendors;
receiving at least one acceptance of the outbound bid to perform the pending reconditioning task at or less than the maximum pending reconditioning task cost value from at least one of the target vendors and/or accepting at least one inbound bid received in response to the inbound bid request to perform the pending reconditioning task at or less than the maximum pending reconditioning task cost value from at least one of the target vendors to form at least one pending reconditioning task agreement with a selected vendor from the population of target vendors;
tracking performance of the pending reconditioning task agreement by the selected vendor; and,
updating the pending reconditioning task record at least when the selected vendor completes performance of the pending reconditioning task agreement to produce an updated reconditioning task record.

24-32. (canceled)
